(19) United States
(12) Patent Application Publication
(10) Pub. No.: US 2007/0286092 A1
(43) Pub. Date: Dec. 13, 2007

(54) Method for use of preference list to manage network load and user experience in a multi-network environment

(76) Inventors: David Famolari, Stewartsville, NJ (US); Shoshana Loeb, Philadelphia, PA (US); Komandur Ramu Krishnan, Bridgewater, NJ (US); Benjamin Falchuk, Nyack, NY (US); Moncef Elaoud, Lake Hopatcong, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/729,456

(22) Filed: Mar. 29, 2007

Related U.S. Application Data
(60) Provisional application No. 60/788,362, filed on Mar. 31, 2006.

(51) Int. Cl. G08C 15/00

(52) U.S. Cl. 370/252; 370/465

(57) ABSTRACT

System, method and program storage device for use of preference list to manage network load in a multi-network environment are provided. In one aspect, a preference list is generated that includes one or more of networks for connecting a device in a multi-network environment. The preference list is adjusted to take into account one or more policy factors and transmitted to the device for the device to use for selecting a network for communicating.

### CROSS-REFERENCE TO RELATED APPLICATIONS

This application claims the benefit of U.S. Provisional Application No. 60/788,362, filed on Mar. 31, 2006, which is incorporated herein by reference in its entirety.

### FIELD OF THE INVENTION

The present application relates generally to mobile communications and network management, and more particularly, to supporting intelligent network-centric admission control in multi-network environments.

### BACKGROUND OF THE INVENTION

Recent advances in telecommunication technologies allow consumer devices to deliver voice, video and data sessions over several network access technologies. The emergence of multi-mode phones is transforming the telecom world and requires quick adaptation by mobile and fixed service providers. Today, many technologies are available for carrying voice and data sessions, including GSM, UMTS, WiFi, WiMAX, PSTN, cable and DSL, etc., each with its own technical, operational and economic characteristics. The increase of multi-mode devices together with the increase of geographic areas offering multiple access technologies is expanding the space of connectivity strategies. For example, dual-mode 3G/Wi-Fi phones within a hotspot will be able to initiate and receive voice calls over either the Wi-Fi or the 3G network. Exercising appropriate connectivity choices can have a large impact on both individual session performance as well as network system performance.

Existing methodologies enable multi-mode devices to switch connections from one networking technology to another. Examples include the Unlicensed Mobile Alliance (UMA) and the Voice Call Continuity (VCC) efforts within the 3GPP. In general, these types of approaches are referred to as Fixed Mobile Convergence (FMC) technologies. These approaches, however, do not try to determine when and where connections should be switched. Rather, they provide execution platforms and protocols that enable these switches to take place. Providers who implement FMC-type solutions often implement simple heuristics as network selection decisions. Most solutions rely solely on information local to the mobile device, usually received signal strength, to make connection decisions. Signal strength alone, however, may not be a sufficient indicator of performance, as it provides no indication of congestion, capacity or core-network delays. For example, strong Wi-Fi signals may indicate that the underlying physical bit rate will be high; however, link throughput is heavily influenced by the number of contending stations and their transmission characteristics.

Relying on local device information also may limit the role that the network plays in allocating resources across the different access technologies. Allowing the network to play a central role may lead to better load balancing and more efficient resource utilization because the network can have better visibility of loads and activities across both access technologies. While existing approaches perform load balancing across networking, those solutions have tended to focus on reactive approaches such as diverting traffic to an alternative network when a serving network becomes overloaded.

Thus, it is desirable to effectively manage potential traffic on multi-mode networks and allows user devices to connect to appropriate network when able to choose between more than one. It is also desirable that the aggregated behavior of a set of users connecting to networks meets some goal of an operator or provider, for instance, with respect to network load. It is further desirable to take into account the user experience in such management and connection of traffic in multi-mode networks.

### BRIEF SUMMARY OF THE INVENTION

System, method and program storage device for use of preference list to manage network load in a multi-network environment are provided. A method in one aspect may comprise generating a preference list including one or more of networks for connecting a device in a multi-network environment, adjusting the preference list to take into account one or more policy factors, and transmitting the preference list to the device. A preference list in one embodiment may be a tangible message transmitted between agents using well-understood semantic and syntax. A preference list may embody one agent's preference for how another agent should make use of local resources.

A program storage device readable by a machine, tangibly embodying a program of instructions executable by the machine, in one aspect, performs the above described method steps.

A system for managing network load in a multi-network environment using a preference list, in one aspect, may comprise an analysis engine module operable to determine network load from at least one or more sensors in one or more networks, a preference list management module operable to generate a preference list including one or more of networks for connecting a device in a multi-network environment based on the network load, and a policy decision point module operable to adjust the preference list to take into account one or more policy factors.

A system for managing network load in a multi-network environment using a preference list, in another aspect, may comprise means for generating a preference list including one or more of networks for connecting a device in a multi-network environment, means for adjusting the preference list to take into account one or more policy factors, and means for transmitting the preference list to the device.

In one aspect, a preference list may be generated based on a network load and one or more policy factors. One more policy factors may include, but are not limited to, one or more of user experience associated with said one or more networks, business rules, carrier policies associated with said one or more networks, user policies associated with said one or more networks, or combinations thereof.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates the high level diagram of multi-network regions in one embodiment of the present disclosure.

FIG. 2 is an architectural diagram illustrating various functional components of the system of the present disclosure in one embodiment.

FIG. 3 illustrates an example of use-case involving the Policy Decision Point (PDP) in one embodiment of the present disclosure.

FIG. 4 illustrates a call flow in one embodiment of a User Agent (UA) registering with a system.

FIG. 5 illustrates a call flow in one embodiment of a UA monitoring the availability of local networks.

FIG. 6 shows a call flow in one embodiment of transmitting a preference list message to a UA.

FIG. 7 illustrates a call flow in one embodiment of a UA overriding the recommendations of a preference list (PL).

FIG. 8 illustrates a call flow in one embodiment for requesting UA connection.

FIG. 9 illustrates a call flow in one embodiment of using a request connection message while anchoring an incoming “call” to a UA device.

### DETAILED DESCRIPTION

A method of the present disclosure in one aspect provides a network-centric framework that incorporates live traffic conditions with carrier and user policies to influence connectivity decisions in a multi-network environment, thereby improving network traffic level and/or mobile user experience. In the description, the term, “framework” is used interchangeably with the term “system.”

In one embodiment, PL's may account for other business policies in addition to network-centric ones.

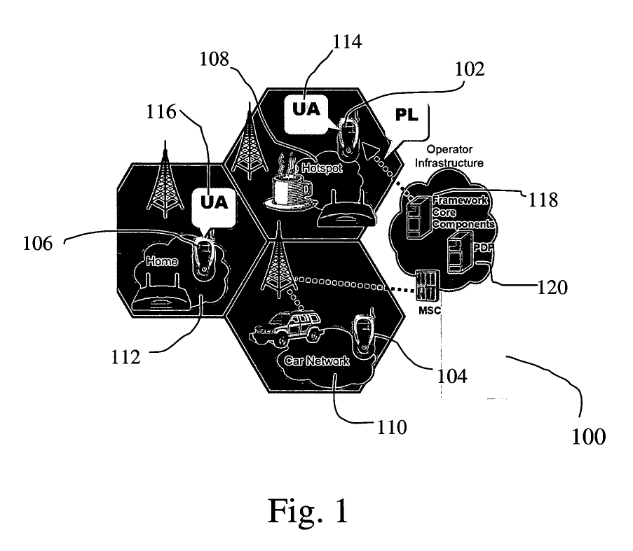

FIG. 1 illustrates the high level diagram of multi-network regions 100 in one embodiment of the present disclosure. Mobile devices such as dual-mode cellular phones 102, 104, 106 are shown in various places 108, 110, 112; at each place both the cellular and some other (WiFi) network may be available. Often, more than one other WiFi may be available. In one embodiment of the present disclosure, user agents (UA) 114, 116 are resident on mobile devices. UA, for example, may be low-level software application or hardware component or combination of both, resident on the terminal. UA may run on, for example, Symbian and Windows CE Operating Systems or other systems. UA may be user transparent. Preference List (PL) refers to an extensible set of information relating to how calls should be distributed onto the available networks, for an individual user or group, and a set of reachable networks. In one embodiment, UA's receive and interpret PL's; for example, PL's may be emitted via SMS or other push technology or other technology, and UA's may receive PLs vis a vis network choice.

A system of the present disclosure may include various components 118 situated in the operator infrastructure and have access via interfaces to managed network elements (NE's) via element management systems (EMS). The system and method of the present disclosure, for example, access NE's to provide PLs. The system of the present disclosure may gather and manage network-centric information related to admission control, formulate PL's and emit them, for example, periodically. One or more policy decision point (PDP) 120 may play a role in the information sent to UA's. For example, the system of the present disclosure may interwork with a PDP for non network-centric admission decisions. PDP 120 for instance may be a policy engine dedicated to extensible policies that relate business-level parameters with admission control, e.g., promotions, profiles, etc. Thus, in one embodiment, PL's may account for other business policies in addition to network-centric ones.

In one embodiment, UA runs upon the phone to process PL's to decide on an interface for the next outgoing call. In one embodiment, PL's are effective “in-network” as well, allowing for anchoring of incoming calls to a multi-networked user on any one of them, depending on the current state(s) of the networks in question.

A device may register with the system and method of the present disclosure, for example, together with a registration with a new MSC or AP. The system and method of the present disclosure in one embodiment may store information about networks seen by device, interfaces, etc. As networks become available other registrations may be made. For outgoing voice call from UA devices, a UA may broker the outgoing call transparently to the user by consulting the PL and computing the outbound network interface. For handling network congestion in one embodiment, changes in network loads trigger updates to PL's, which may be then periodically emitted to UA's. The system and method of the present disclosure in one embodiment may also perform proactive computation. For instance, a predetermined timer or time-of-day heuristic may trigger reconsidering of the admission policies and regeneration of PL's.

For voice call bound for a multi-networked device, the system and method of the present disclosure in one embodiment may determine the appropriate anchor network for the terminating side of the call based on various state data. In one embodiment, PLs may be modified based on business-level policies (promotions, preferences, etc.) at one or more auxiliary PDP's before the system and method of the present disclosure sends computed PL to a UA. This allows the system and method of the present disclosure in one embodiment to take into account the individual user or group, that is, achieve “customized” PL's. Similarly, on the terminating call decision case, the PDP's may take information about the specific terminating client, device, or business policies into account.

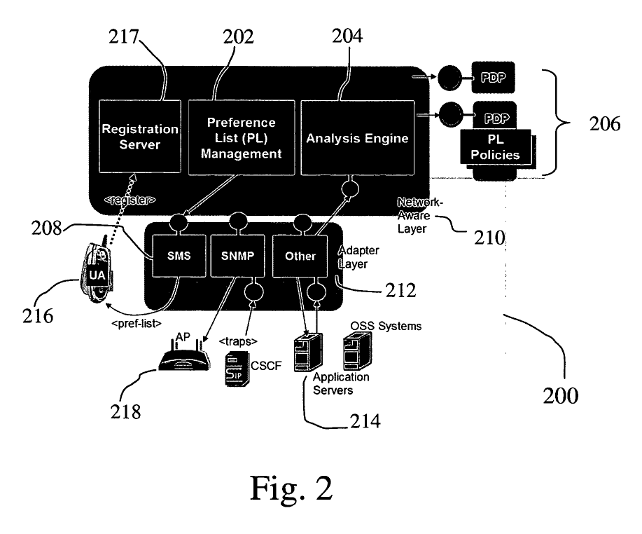

FIG. 2 is an architectural diagram 200 illustrating various functional components of the system of the present disclosure in one embodiment. PL includes data that can be interpreted by a UA and provides a recommendation of network or what network ordering should be used when attempting outgoing “calls.” Analysis engine 204 computes the appropriate network load based on sensors in EMS and other network information. PDP 206 is a policy decision point for preference list refinement. PL management 202 creates instances of preference lists, possibly customized for individual UA's, and manages their transmission, for example, via SMS 208, MMS, IM, TCP/IP, and other mechanisms. Other lower level system components may respond to alarms and information from EMS's and NE's. NE's may include, but are not limited to, 802.11 Access Points (AP's) 218, Mobile Switching Centers (MSC), Base Station Controllers (BSC), and equipment providing Session Control Function (SCF). In general, various components, shown in FIG. 2 as network aware layer 210, manage device registration, provide a common mapping layer, and respond to network-based events such as congestion, perform mathematical analysis, and manage PL's. Various components, shown in FIG. 2 as adapter layer 212, may provide mapping functions to external system such as NE's and application servers 214.

A user agent 216 in one embodiment may provide network monitoring, network registration, and network policy enforcement functionalities. For instance, the user agent 216 may continuously monitor its network interfaces and gather information that aids in derivation of the policy solution (PL). Information collected may include, but is not limited to, type of networks supported such as 2.5G, 3G, 802.11b, 802.11g, Bluetooth; list of active interfaces and their link quality such as SNIR, power level, transmission rate; list of networks the device is associated with; list of reachable networks to which the user device can potentially connect; parameters for the available networks such as ESSID for WLANs, cell ID for 3G networks, transmission power levels, transmission rates; user's current GPS coordinates.

At start up, the user agent in one embodiment may register with a system server, for example, a registration server 217, providing the server with information to be used during the policy decision. The user agent may provide the server with information such as a unique user device identifier; a list of the user device capabilities such as device make and model, IMS ready, processing power, memory capabilities; current device GPS coordinates; types of network supported such as Bluetooth, WLAN, 2.5G, 3G, etc.; a list of networks the user device is associated with; a list of network choices within its reach. This information may include ESSIDs of WLAN networks, cell IDS of 3G networks, etc.

In one embodiment, a user agent may update its registration any time it encounters, or is able to make an OSI (Open Systems Interconnection) Layer 2 or 3 connection with, a new network resource. An OSI layer, for example, provides the functional and procedural means to transfer data between network entities. A user agent may also update a registration if its hosted device capabilities change in some way. This may keep the system server up-to-date with the mobile terminal capabilities and network choices.

A user agent in one embodiment may be responsible for receiving and properly applying any network selection policies sent by the policy server. The user agent may refine the policies before applying them to call initiations. For example, the policy server may instruct the user agent to use network A if the SINR on that link is above a certain threshold, otherwise network B should be selected. In this case, the UA may use its measurements to finalize the policy decision.

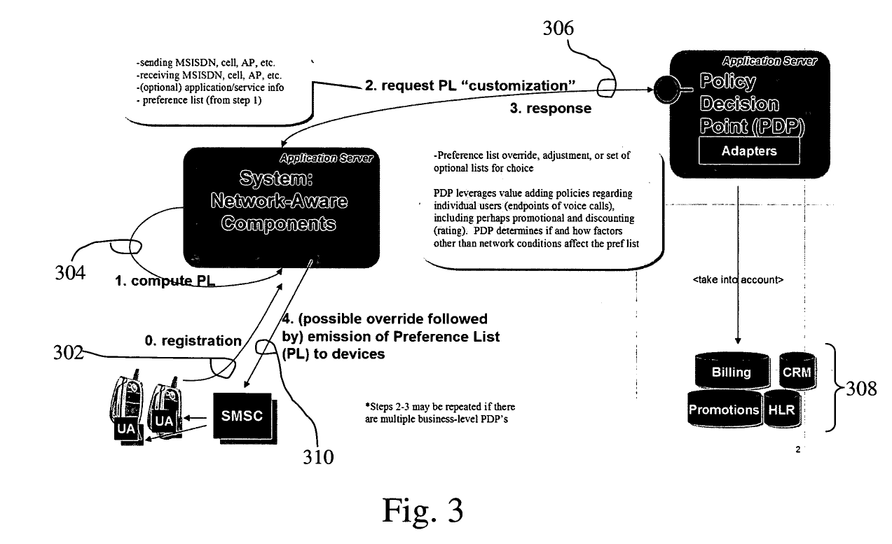

FIG. 3 illustrates an example of use-case involving the PDP in one embodiment of the present disclosure. At 302, a UA registers with the system. In one embodiment, the system may compute a PL shown at 304 for the UA. In another embodiment, the system may use an existing or some historical one without computation. At 306, a PDP is requested to customize the PL for this UA, for example, based on information in other remote databases 308, for example, Billing, Home Location Registry, etc. The PDP responds with the PL, possibly modified. The calling components may accept or reject the PDP modifications and transmit the PL to the UA as shown at 310. The UA uses the PL to determine network to use for subsequent calls.

In one embodiment, communication between UA and the system (for example, network aware components) is described by a Messaging “protocol”. All such messages may contain unique identifiers and sequencing numbers as well as a message type and payload. In one embodiment, all messages may contain a unique customer/device identifier and sequencing information. The following describes examples of message types, which may be communicated between UA and various system components of the present disclosure. The message types are not limited to those described below, but may include additional or other types.

REGISTER message type may be used by UA to announce its presence. Payload may include, but is not limited to: current GPS coordinates, the network types supported by the device (e.g. WLAN, GSM), networks detected by the device, networks connected to, device name, type and device attributes.

PREF_LIST message type may be used by system to encode PL information to UA. This message may include an ordered list of networks to try or a list of networks each with a probability value. In the latter case, the UA creates a random number and picks the network adapter based on the PL probabilities. For instance, the UA may be given the “rule” but still may generate a random number and determine which part of the rule to use, for example, which network. PREF_LIST may also include network identifiers (ID's) and keys. Other authentication information may be supplied.

UPDATE message type may be used by UA to update its registration information. Information in the message may include the ID's of networks currently in-range, a list of networks to which the device is currently connected; UPDATE may also include, but is not limited to, other unlimited sorts of meta-data about network resources “near” the UA (which need not necessarily be transmission networks).

OVERRIDE message type may be used by UA to announce to the system that it overrided a recommendation contained in the PL. The message may contain the reason of the override, the new order of network selection as well as the original (overrided) information, and network ID (all networks in question) information.

REQUEST_PREF_LIST message type may be used by UA to request a PL from system. Response from system is a PREF_LIST message.

REQUEST_CONNECTION message type may be used by system to request that UA establish a network connection to a particular network. Also supplied may be the network ID and authentication information (keys, etc.). REQUEST_BREAK_CONNECTION from system message type may similarly request that UA remove a network connection.

ACK message type may be used to acknowledge a message and may be used by the system to a UA or by a UA to the system and may acknowledge receipt of any previous message.

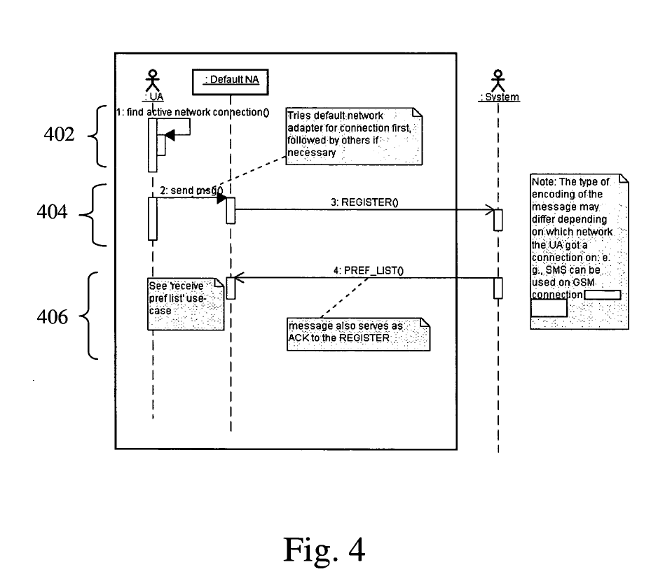

FIG. 4 illustrates a call flow that may occur in one embodiment when a device is started. When a device is powered on the UA may start, gather information, and may send a REGISTER message to the system. System may respond with a PREF_LIST message. At 402, UA finds active network connections. At 404, a UA sends a message to a default network. For instance, the UA may try default network adapter for initial connection. The UA also sends a register message to the system, that is, one or more functional components of the system of the present disclosure. At 404, the system sends a preference list to the UA. From UA's point of view, receipt of a preference list may also serve as the acknowledgement of a previously transmitted REGISTER message.

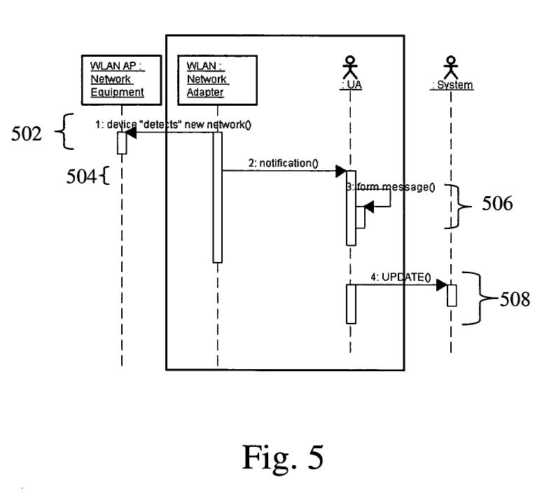

FIG. 5 illustrates a call flow in one embodiment in which a UA monitors the availability of local networks both “seen” and “connected to”. When this list changes it sends an UPDATE message to the System. System may respond with a PREF_LIST message. At 502, a network adapter of a device (e.g., a mobile device such as cellular phone, etc.) detects new network and notifies a UA, for example, resident on the device at 504. At 506, the UA forms a message and at 508 sends the update message to one or more functional elements of the system of the present disclosure.

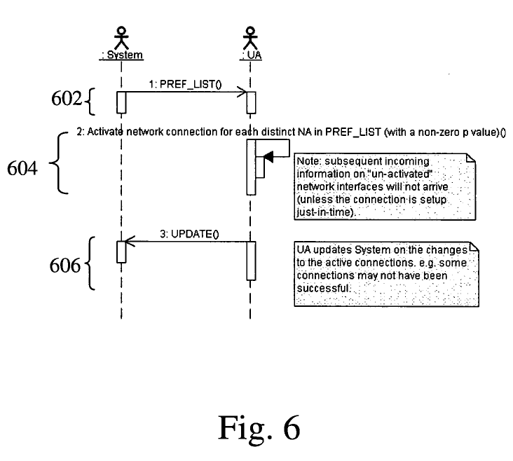

FIG. 6 shows a call flow in one embodiment that illustrates how the system may send a PREF_LIST message to the UA. At 602, one or more functional components of the system of the present disclosure send a preference list to a UA. At 604, the UA proceeds to attempt network connections to each (non-zero probability) network specified in the PL. At 606, if the resulting set of connected-to networks is different than before the PREF_LIST message the UA sends the updated information, for example, in an UPDATE message to the system.

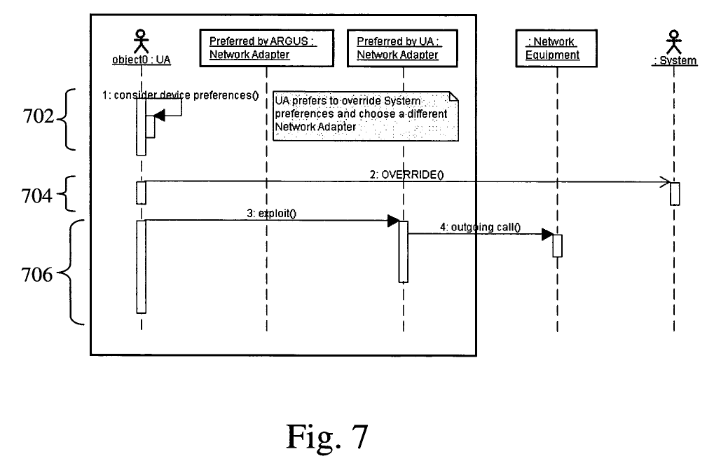

FIG. 7 illustrates a call flow in one embodiment in which if a UA deliberately does not heed the recommendations of the PL in some way it informs the system of its overriding local decision using an OVERRIDE message. At 702, the UA considers the network options specified in the PL, and decides that it is preferred to override the system recommendation. At 704, the UA sends a message to the system notifying the system that it is overriding the preference list. At 706, the UA uses its preferred network for calls.

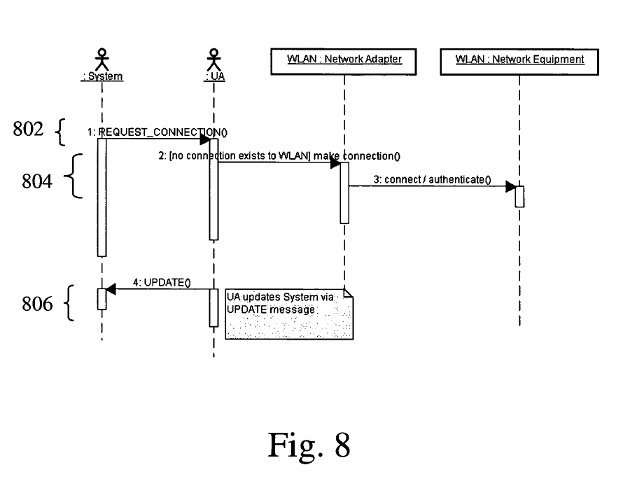

FIG. 8 illustrates a call flow in one embodiment in which a UA is requested to reconnect. A system and method of the present disclosure may, for example, from time to time, understand that the UA device has insufficient connectivity to particular networks and request that the UA establish a connection, for example, using a message such as the REQUEST_CONNECTION message. The UA, when completed (either success or failure) sends an UPDATE message in response. At 802, one or more functional components of the system of the present disclosure requests, for example, periodically, the UA to establish connection with a network. At 804, the UA determines whether the UA is connected to the network, and if not, makes the connection. At 806, the UA sends a message, for example, an UPDATE message, informing the connection status, for instance, re-establishment of the connection to the specified network if the connection was successful. If the connection attempt failed, the UA may send a message to that effect.

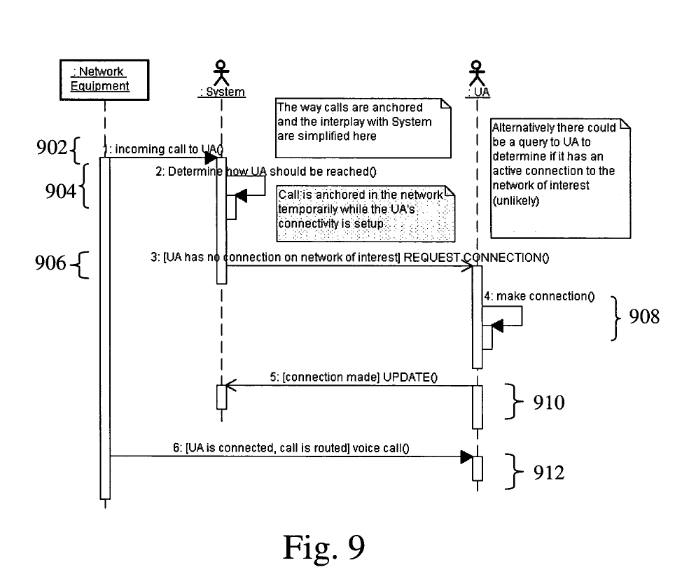

FIG. 9 illustrates a call flow in which the system may request a connection message for an incoming call. The system may use a message such as the REQUEST_CONNECTION message while it is anchoring an incoming “call” to a UA device. In this case, the system wishes to route the call to the device using a particular network but understands that the device has no active connection to that network. The REQUEST_CONNECTION message prompts the UA to make that connection. When successful the system can subsequently route the “anchored” and held call to the device on that new, and may be more desirable, connection. At 902, the system receives an incoming call directed for a particular UA. At 904, the system determines how that UA should be reached. In another embodiment, the system may query the UA to determine if it has an active connection to the network of interest. The call may be anchored in the network temporarily while the connectivity to the UA is being setup. At 906, if the system determines that the UA has no connection to that network, the system requests the UA to make the connection. At 908, the UA makes the connection to the network of interest and at 910 informs the system. At 912, the system routes the call to the UA using the network connection.

In another embodiment, a more passive mode can be realized in which the Preference List is displayed to the user as a form of “recommendation” and the choice of whether or not to use the list's advice is left up to the user. This “recommendation” may be in the form of a textual message or in some graphical format easily understood by the users who receive it on their mobile phones and it may present a sole recommendation or a set of recommendations displayed in some sorted order (based on a metric understood by the user). A textual “explanation” or “reason” may accompany each recommendation.

The following description provides model formulation methodology used in the system and method of the present disclosure in one embodiment. For a geographical location in which wireless access is possible for voice-calls both via a WLAN and via a cellular network, for example, a GSM network, the system and method of the present disclosure consider policies for allocating the offered load between these two access networks, with a view to minimizing call-blocking. While in the below example model formulation, two networks (WLAN and cellular) are considered, it should be understood that the system and method of the present disclosure may apply to other multi-network environments, for example, with more than two and other types of networks.

The system and method may model the total offered load to the two networks as a Poisson stream of voice-calls arriving at rate λ, with an average holding time of τ, for an offered load of a=λτ erlangs. In this model, the possibility is provided that a certain fraction of the originating calls may be constrained to be carried only on the WLAN or only on the cellular network, leaving only the remaining originating calls, which we label as “dual-mode”, as candidates for allocation-choice between the two networks.

Let,

f_{w}=fraction of calls constrained to be attempted only on the WLAN.

f_{c}=fraction of calls constrained to be attempted only on the cellular network.

f_{d}=fraction of “dual-mode” calls, assignable to either network according to some policy.

We have, f_{w}+f_{c}+f_{d}=1

We also define,

a_{w}=af_{w}=offered load of WLAN-constrained calls, in erlangs

a_{c}=af_{c}=offered load of cellular-constrained calls, in erlangs

a_{d}=af_{d}=offered load of dual-mode calls, in erlangs

We model the voice channels in the cellular network, more precisely, the cellular sector in which the mobile is situated, as a loss system including N_{c} trunks. A WLAN, unlike the cellular network, has no intrinsic mechanism for rejecting additional users. Therefore, in one embodiment, an appropriate model for a WLAN without admission control is a non-blocking system of an infinite number of servers, in which, however, the performance seen by each customer depends on the number of customers present in the WLAN. However, for given parameters of the WLAN and for given performance requirements that are considered acceptable for voice-calls (delay, jitter, and loss rate), we assume that we can determine N_{w}, the maximum number of simultaneous calls that can be present in the WLAN for acceptable performance. We now suppose that we can enforce an admission policy in the WLAN by turning away arriving calls that find N_{w} other calls already in progress. We can then view the WLAN, for purposes of admitting voice-calls, as a trunk-group of size N_{w}.

Various policies for assignment of network traffic may be used. For instance, various policies may be considered for assigning the dual-mode calls to either the WLAN (W) or the cellular network (C). Examples of policies may include but are not limited to hunting policies and state-dependent policy for individual calls.

Hunting policies may include fixed sequence and optimized random sequence.

In a fixed sequence of W→C, each dual-mode call attempts the WLAN first; if blocked there, it attempts the cellular network.

In a fixed sequence of C→W, each dual-mode call attempts the cellular network first; if blocked there, it attempts the WLAN.

In an optimized random sequence, where

Optimized Random Sequence: p_{w} (W→C)+p_{c} (C→W)

a specified fraction p_{w} of the dual-mode calls follows the attempt sequence (W→C), and the remaining fraction p_{c}=(1−p_{w}) follows the attempt sequence (C→W), where p_{w} is calculated to minimize the overall blocking under this random policy. Optimized random sequence may attempt to find an “optimum” combination of the above two fixed sequence policies.

If f_{d}=1 (i.e., if all the traffic is dual-mode), the attempt sequence may be immaterial; all three hunting policies have the same effect, viz., of offering the total load of a erlangs to a single trunk-group of (N_{w}+N_{c}) trunks. Thus, in this degenerate case when f_{d}=1, the “policy” may attempt every available choice.

In state-dependent policy for individual calls, we now consider a policy in which an assignment-decision is made for each arriving call on the basis of the occupancies of the two networks at the time of call arrival. One embodiment of this policy enables a centralized network controller to enforce such call-by-call decisions. In another embodiment, approximate versions of such state-dependent policies can be constructed in which the instantaneous state at call-arrival is replaced by the most recent “snapshot” of state, taken at regular intervals, and assignment rules are downloaded into user terminals for use until the next update.

Considering the embodiment in which a centralized network controller may enforce call-by-call decisions, let

n_{w}=number of calls in progress in the WLAN

n_{c}=number of calls in progress in the cellular network

at the instant of arrival of a new call of the “dual-mode” portion of the stream.

If n_{w}=N_{w}, the call is blocked on the WLAN,

if n_{c}=N_{c}, the call is blocked on the cellular network, and

if n_{w}=N_{w} AND n_{c}=N_{c}, the call is blocked on both networks.

Define also
A_{w}=a(f_{w}+f_{d}p_{w})
A_{c}=a(f_{c}+f_{d}p_{c})
where p_{w} and p_{c} are the values earlier for the optimum hunting policy. We can regard A_{w} and A_{c} as “nominal” loads on the two networks, used for defining the following “admission costs” for the new call on the two networks:

$${D}_{w} ( {n}_{w} ) = [ \frac{B ( {N}_{w} , {A}_{w} )}{B ( {n}_{w} , {A}_{w} )} ]$$

$${D}_{c} ( {n}_{c} ) = [ \frac{B ( {N}_{c} , {A}_{c} )}{B ( {n}_{c} , {A}_{c} )} ]$$

where the function B(m,θ) is the Erlang-B blocking formula, expressing the probability of call-blocking when a Poisson load of θ erlangs is offered to a trunk-group having m trunks.

Then, the state-dependent rule for selecting the network for the call can be expressed as follows:

If D_{w}(n_{w})<D_{c}(n_{c}), admit the call on the WLAN

If D_{w}(n_{w})>D_{c}(n_{c}), admit the call on the cellular network

If D_{w}(n_{w})=D_{c}(n_{c}), choose either network at random

The method of the present disclosure allows the network provider to play a more central role in influencing connection decisions, for example, by incorporating global information, dynamic business rules, and carrier and user policies and interacting directly with the mobile devices. The method in one embodiment attempts to influence the behavior of the end hosts, for instance, by interacting with them directly. The method in one embodiment also provides proactive and network-centric approach and enables the network to influence the behavior of mobile stations before they send traffic.

Network selection decisions in the present disclosure consider the network and end-user device. This network-assisted solution may rely on a client-server architecture where the client provides neighborhood and perceived experience information to the network server. The server gathers network information such as network load, network availability, etc. The network information and the user-provided information in one embodiment form the basis for the decision made by the server.

Further, the system and method of the present disclosure in one embodiment may automate the network selection processes. In addition, the system and method of the present disclosure in one embodiment may allow for the end-user device to be attached to several networks at once. The network preference may be generated on a per service basis. That is, for example, the system and method of the present disclosure may allow for voice service to use network A and data service to use network B. Yet in another aspect, the UA's of the present disclosure need not be visible to a user and need not offer applications themselves to the user.

Policy-recommendations sent to the user take account of the existing loads, for example, average arrival rates, average holding times of calls, etc., on the various alternative networks available for multi-mode calls in determining a load-allocation. Such recommendations may minimize congestion and thus make for a better user-experience. Further, in those cases where a particular fixed order may be the better form of a “hunting” policy, the system and method of the present disclosure may opt for that fixed policy.

If, in addition, to the information on average rates and holding times, we also have access to the actual current occupancies of the networks at the instants of multi-mode call-arrivals, then the system and method in one embodiment of the present disclosure may propose a call-by-call, state-dependent rule that makes a deterministic decision for each arriving call as to which available network it should be carried on. In another aspect, an approximate state-dependent policy may be derived on the basis of network occupancies measured at regular intervals rather than at every call arrival.

In one embodiment of the present disclosure, the network selection is based on many factors including network provider goals, network conditions, user experience, user preference, etc. The system and method of the present disclosure in one embodiment proactively influence end-user devices prior to connection establishment. This results in avoiding the network from being overloaded and congested. In addition, proactive user biasing reduces the bad user experience as users are generally steered away from congested networks before they connect to them. In one aspect, the burden of having to interact with the mobile device in order to ensure that it uses an appropriate network may be eliminated. The user need not understand how or when to tell its device to interwork with various network technologies.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc. A module may be a component of a device, software, program, or system that implements some “functionality”, which can be embodied as software, hardware, firmware, electronic circuitry, or etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for use of preference list to manage network load in a multi-network environment, comprising:
generating a preference list including one or more of networks for connecting a device in a multi-network environment;
adjusting the preference list to take into account one or more policy factors; and
transmitting the preference list to the device.

2. The method of claim 1, wherein the one or more policy factors include one or more of user experience associated with said one or more networks, business rules, carrier policies associated with said one or more networks, user policies associated with said one or more networks, or combinations thereof.

3. The method of claim 1, further including:
receiving registration request from a user agent associated with a device for connecting to a network in a multi-network environment, wherein the step of generating is performed in response to receiving the registration request.

4. The method of claim 1, wherein the step of generating includes using a pre-existing list.

5. The method of claim 1, further including:
periodically regenerating the preference list based on dynamics of the plurality of networks.

6. The method of claim 5, further including:
transmitting the regenerated preference list to the device.

7. The method of claim 1, further including:
periodically regenerating the preference list based on one or more changing admission policies associated with said one or more networks.

8. The method of claim 1, further including:
periodically regenerating the preference list based on one or more changes in network loads associated with said one or more networks.

9. The method of claim 1, further including:
periodically sending a request to the device for re-establishing connections to said one or more networks; and
regenerating the preference list based on the device's ability to establish connections to said one or more networks.

10. The method of claim 1, further including:
periodically receiving status of one or more connections to said one or more networks from the device; and
regenerating the preference list based on the status received.

11. The method of claim 1, wherein the steps of generating and adjusting the preference list further includes:
using state-dependent policy for individual calls for selecting said one or more networks.

12. The method of claim 1, wherein the steps of generating and adjusting the preference list further includes:
using one or more hunting policies to select said one or more networks.

13. The method of claim 1, wherein the device is a mobile device.

14. The method of claim 1, further including:
receiving notification from the device that the device is overriding the preference list.

15. The method of claim 1, further including:
receiving an incoming call directed to the device;
selecting a network to use for connecting the incoming call based on one or more network load and one or more policy factors;
requesting the device to establish connection with the selected network; and
routing the incoming call via the selected network.

16. The method of claim 1, further including:
selecting a network from said one or more networks for the device to communicate.

17. A system for managing network load in a multi-network environment using a preference list, comprising:
an analysis engine module operable to determine network load from at least one or more sensors in one or more networks;
a preference list management module operable to generate a preference list including one or more of networks for connecting a device in a multi-network environment based on the network load; and
a policy decision point module operable to adjust the preference list to take into account one or more policy factors.

18. The system of claim 17, wherein the preference list management module is further operable to transmit the preference list to the device.

19. The system of claim 17, wherein the one or more policy factors include one or more of user experience associated with said one or more networks, business rules, carrier policies associated with said one or more networks, user policies associated with said one or more networks, or combinations thereof.

20. The system of claim 17, wherein the analysis engine module is further operable to dynamically determined network load based dynamically detected information from the one or more sensors and the preference list management module is further operable to regenerate the preference list based on the dynamically determined network load.

21. The system of claim 17, wherein the preference list management module is further operable to regenerate the preference list based on one or more changes associated with the one or more policy factors.

22. The system of claim 17, further including a user agent associated with the device, the user agent operable to receive the preference list and select a network for the device to use based on the preference list.

23. The system of claim 17, further including a user agent associated with the device, the user agent operable to receive the preference list and select a network for the device to use based on the preference list and one or more criteria associated with the device.

24. A system for managing network load in a multi-network environment using a preference list, comprising:
means for generating a preference list including one or more of networks for connecting a device in a multi-network environment;
means for adjusting the preference list to take into account one or more policy factors; and
means for transmitting the preference list to the device.

25. A program storage device readable by machine, tangibly embodying a program of instructions executable by the machine to perform a method for use of preference list to manage network load in a multi-network environment, comprising:
generating a preference list including one or more of networks for connecting a device in a multi-network environment;
adjusting the preference list to take into account one or more policy factors; and
transmitting the preference list to the device.
